(19) United States
(12) Patent Application Publication
(10) Pub. No.: US 2008/0219612 A1
(43) Pub. Date: Sep. 11, 2008

(54) Shielded bearing and method

(75) Inventors: David R. Smith, Fort Jennings, OH (US); Richard Raymond Anderson, Cloverdale, OH (US); Mark Allen Recker, Ottawa, OH (US)

Correspondence Address: ROTHWELL, FIGG, ERNST & MANBECK, P.C., 1425 K STREET, N.W., SUITE 800, WASHINGTON, DC, 20005, US

(73) Assignee: Unverferth Manufacturing Company, Kalida, OH (US)

(21) Appl. No.: 11/715,451

(22) Filed: Mar. 8, 2007

(51) Int. Cl. F16C 33/72

(52) U.S. Cl. 384/624

(57) ABSTRACT

A method and system for shielding bearings from foreign materials such as soil, weeds, plant residue and moisture during the operation of farm equipment. A rotating bearing shield for a bearing includes a cover member having a first end shaped to match the external shape of a bearing housing, including a means for coupling said cover member with an inner race of said bearing and a means for accepting an axle there through. The rotating bearing shield can be pressed onto the inner race of the bearing assembly to form a shielded bearing assembly. Additionally, the shield can be sized to maintain an appropriate press-fit that does not compress the inner race beyond an acceptable inside diameter.

### BACKGROUND OF THE INVENTION

1. Field of the Invention

The present invention relates generally to a system and method for shielding bearings used in tillage equipment from foreign material such as soil, weeds, plant residue and moisture.

2. Description of the Related Art

Tillage equipment includes rotating members that often employ bearing assemblies to allow the members to rotate. During the operation of tillage equipment, foreign material (e.g. soil, weeds, plant residue, moisture, etc.) can combine to form a compacted fibrous mass on the rotating members of tillage equipment that engage the ground. This fibrous mass tends to “spool” around the edges of the rotating members of the tillage equipment, thereby exerting pressure on exposed bearing seals. Further, the exerted pressure increases during equipment operation as the fibrous masses spool tighter around the tillage equipment with each successive rotation. As a result, the compacted mass exerts even more pressure against the bearing seals.

One prior attempt to mitigate the negative effects of such spooling fibrous mass involves placing stationary shields over the bearings to restrain the spooling mass. The efficacy of such stationary shields depends on a close tolerance between the rotating shaft and the shield; any misalignment between the shaft and the shield could cause distortion of the shield and allow the spooling mass to exert pressure on the bearing seal. An additional problem with this method is the installation or replacement of the stationary shields tends to be time consuming and requires specialized knowledge and tools.

Another proposed method for protecting a bearing seal involves the use of separate shields fixed to the rotating shaft of tillage equipment. Fixing the shield to the rotating shaft can effectively prevent the spooling fibrous mass from pushing against the bearing seal with a close tolerance between the rotating shield/shaft and stationary bearing housing. Achieving the required tolerance, however, requires specialized tools and knowledge, and accordingly, installations or replacements are expensive and time consuming. Additionally, because the shield must be assembled to the shaft and not the bearing, alignment must be controlled precisely, which requires additional adjustments.

Thus, there exists a need in the art for new and improved systems and methods for shielding bearings. Such new and improved systems and methods should effectively prevent a spooled fibrous mass from exerting pressure on the bearing seal while being installed or replaced as a unit using standard bearing assembly procedures without requiring special tools or alignment fixtures.

### SUMMARY OF THE INVENTION

The present invention provides a system and method for shielding bearings so that shielded bearing assembly can be installed or replaced as a unit using standard bearing assembly procedures and without special tools or alignment fixtures.

According to one embodiment of the present invention, a rotating bearing shield for a bearing comprises a cover member having a first end shaped to match the external shape of a bearing housing, including a means for coupling said cover member with an inner race of said bearing and a means for accepting an axle there through. The rotating bearing shield can be pressed onto the inner race of the bearing assembly to form a shielded bearing assembly. Additionally, the shield can be sized to maintain an appropriate press-fit that does not compress the inner race beyond an acceptable inside diameter.

According to another embodiment of the prevent invention, the shielded bearing assembly is used to rotatably couple a rotating member of a tillage implement for tillage equipment to a support frame. The shielded bearing assembly can be installed or replaced in the tillage equipment using standard bearing assembly procedures.

According to another embodiment of the present invention, a method for protecting a bearing seal used in farm equipment from debris may be employed. The method comprises providing a bearing assembly and sizing a rotating bearing shield to maintain an appropriate press-fit that does not compress the inner race of the bearing assembly. The rotating bearing shield may be coupled to the bearing assembly by pressing the rotating bearing shield onto the inner race of the bearing assembly. This combination forms a shielded bearing assembly.

The system and method of the present invention are ideal for use in tillage equipment but are not limited and may be employed in any use where it would be advantageous to have a shielded bearing seal.

### BRIEF DESCRIPTION OF THE DRAWINGS

FIG. 1 is a schematic drawing of a rotating member for exemplary tillage equipment, on which the present invention may be employed.

FIGS. 2a and 2b are schematic drawings of a shielded bearing assembly according to one embodiment of the present invention.

FIGS. 3a and 3b are schematic representations of a cross-section of the shielded bearing assembly according to one embodiment of the present invention.

### DETAILED DESCRIPTION OF THE PREFERRED EMBODIMENTS

While the present invention may be embodied in may different forms, a number of illustrative embodiments are described herein with the understanding that the present disclosure is to be considered as providing examples of the principles of the invention and such examples are not intended to limit the invention to preferred embodiments described herein and/or illustrated herein.

The preferred embodiments of the invention include novel shielded bearing assemblies implemented within tillage equipment. In various embodiments. The novel shielded bearing assembly can be implemented within any appropriate tillage equipment structure. The following section describes non-limiting examples of illustrative tillage equipment in which embodiments of the present invention can be implemented.

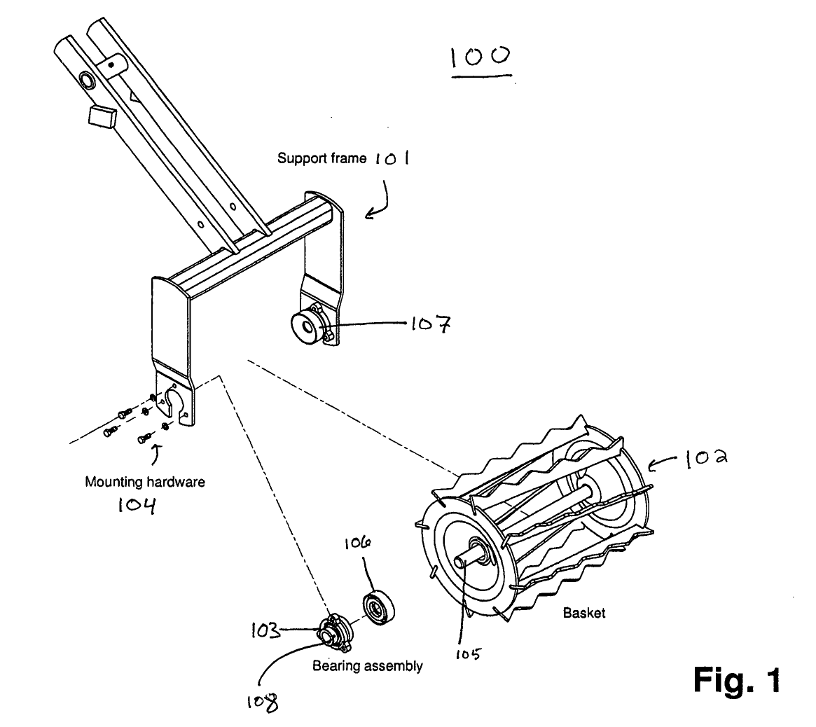

Referring to FIG. 1, and exemplary rotating member for tillage equipment 100 is shown, which can employ a shielded bearing assembly according to an embodiment of the present invention. Shielded bearing assembly 107 may be coupled to a support frame 101 with mounting hardware 104 on one side and to a tillage implement 102 on another side. The tillage implement 102 has an axle 105 about which it rotates. The axle 105 may be coupled to the inner race of the shielded bearing assembly 107 with suitable locking means, which may include a machine screw 108 or any other suitable locking means. During use, fibrous masses can spool around the axle 105. However, the bearing assembly 103 is protect by the rotating bearing shield 106 and the rotating member 102 for the tillage equipment 100 can continue to function normally.

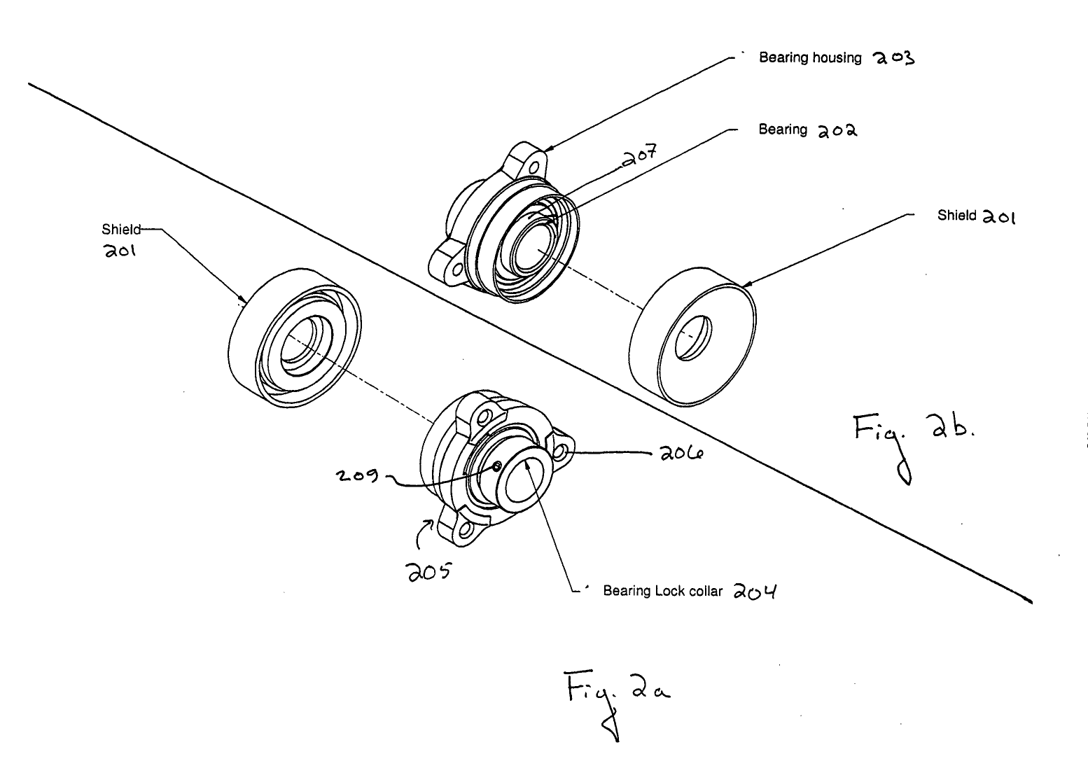

Referring to FIGS. 2a and 2b, constituent parts of the shielded bearing assembly are shown in detail according to an embodiment of the present invention. A bearing housing 203 encloses the bearing 202, which together, comprise the bearing assembly 205 (103). The bearing may be a ball and grease bearing sealed with a standard triple seal. A rotating bearing shield 201 (106) can be machined to maintain an appropriate press-fit, coupling with the bearing assembly 205, by pressing the rotating bearing shield 201 on to the inner race 207 of the bearing assembly 205. One skilled in the art will understand that the fit between the bearing assembly 205 and the rotating bearing shield 201 should be tight enough to prevent materials from damaging the bearing without being too tight, which cold compress the inner race and make installation difficult or impossible. The bearing assembly 205 may include mounting holes 206 that are used to mount the shielded bearing assembly to the support frame 101. The bearing lock collar 204 couples the axle 105 of the tillage implement 102 to the shielded bearing assembly 107 and can be a machine screw 209, but it should be understood that any other mans for locking can be used to fix an axle to the bearing.

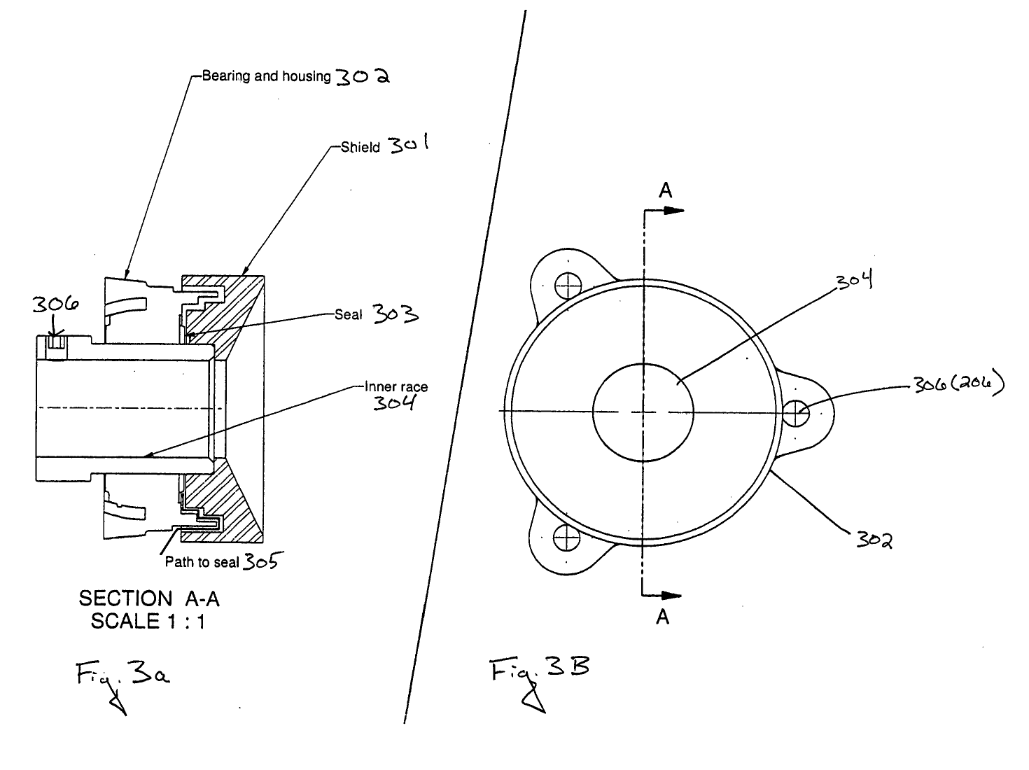

FIGS. 3a and 3b are cross-sectional views of the shielded bearing assembly according to an embodiment of the present invention as shown, the bearing is enclosed in housing 302, which allows an inner race 304 to free-spool as described above, the bearing may be a standard ball and grease type. Accordingly seal 303 maintains grease on the bearing and prevents foreign materials from penetrating the bearing housing which can cause the bearing to fail. The rotating bearing shield 301 protects the bearing seal 303 from any undesirable debris.

Without the rotating bearing shield 301, fibrous plant materials could wrap around the axle 105 of the tillage implement 102 and penetrate the seal 303 thereby impairing the functioning of the tillage equipment 100. The rotating bearing shield 301 forms a tight fit with the bearing assembly and only allows small granular particles, which pose no danger to the seal 303, to pass. The small granular particles that do traverse the path to the seal 305 will not be forced against the bearing seal 303, as would occur without the rotating bearing shield 301. The axle 105 of the tillage implement 102 can be coupled to the inner race 304 and secured by the bearing lock collar 306.

Thus, a number of preferred embodiments have been fully described above with reference to the drawing figures. Although the invention has been described based upon these preferred embodiments, it would be apparent to those of skill in the art that certain modifications, variations, and alternative constructions could be made to the described embodiments within the spirit and scope of the invention.

We claim:

1. A rotating bearing shield for a bearing comprising:
a cover member having a first end shaped to match the external shape of a bearing housing, including a means for coupling said cover member with an inner race of said bearing and a means for accepting an axle there through.

2. The rotating bearing shield as recited in claim 1 wherein the rotating bearing shield is pressed onto the inner race of the bearing assembly to form a shielded bearing assembly.

3. The rotating bearing shield as recited in claim 2 wherein said shield has been sized to maintain an appropriate press-fit that does not compress the inner race of a bearing assembly beyond an acceptable inside diameter and yet enough of a press-fit to keep the shield in place during in-service operation.

4. A shielded bearing assembly comprising:
a bearing assembly enclosing a bearing;
an inner race for receiving an axle; and
a rotating bearing shield coupled to said inner race.

5. The shielded bearing assembly of claim 4 wherein said rotating bearing shield is coupled to said bearing assembly by pressing said bearing shield to the inner race of said bearing assembly.

6. The shielded bearing assembly of claim 4 wherein said rotating bearing shield is sized to maintain an appropriate press-fit that does not compress the inner race of the bearing assembly beyond an acceptable inside diameter.

7. A tillage implement for tillage equipment comprising:
a tillage a rotating member having blades and an axle;
a support frame;
a shielded bearing assembly coupled to said support frame and to said axle by an inner race, said assembly including a rotating bearing shield coupled with said inner race.

8. The tillage equipment of claim 8 wherein said rotating bearing shield is coupled to said bearing assembly by pressing said rotating bearing shield to the inner race of said bearing assembly.

9. The tillage equipment of claim 8 wherein said rotating bearing shield is sized to maintain an appropriate press-fit that does not compress the inner race of the bearing assembly beyond an acceptable inside diameter.

10. A method of protecting a bearing seal used in farm equipment from debris comprising:
providing a bearing assembly;
sizing a rotating bearing shield to maintain an appropriate press-fit that does not compress an inner race of the bearing assembly; and
coupling said rotating bearing shield to said bearing assembly by pressing said rotating bearing shield onto the inner race of said bearing assembly to form a shielded bearing assembly.
